(19) United States
(12) Patent Application Publication
(10) Pub. No.: US 2006/0102008 A1
(43) Pub. Date: May 18, 2006

(54) Apparatus for preparing coffee

(75) Inventor: Yu-Yuan Lin, Tainan City (TW)

Correspondence Address: DILWORTH & BARRESE, LLP, 333 EARLE OVINGTON BLVD., UNIONDALE, NY, 11553, US

(73) Assignee: UNI-SPLENDOR CORPORATION

(21) Appl. No.: 10/988,786

(22) Filed: Nov. 15, 2004

(51) Int. Cl. A47J 31/00

(52) U.S. Cl. 99/279; 220/912

(57) ABSTRACT

An apparatus for preparing coffee is provided in which a secure and efficient seal between a holder of a coffee pouch and a cover of the holder is established. A lid portion and a body portion are hingedly connected to form an access opening therebetween. A holder is mounted on the body portion in the access opening, for receiving a coffee pouch. A cover is fixed to the lid portion in the access opening to cover and seal the coffee pouch in the holder. A plurality of engaging and a plurality of hook members interlock on a one to one basis, when the lid portion is closed against the body portion, thereby closing the access opening and sealing the coffee pouch between the cover and the holder.

### BACKGROUND OF THE INVENTION

1. Field of the Invention

The present invention relates generally to an electric coffee maker, and more specifically, to a pour on demand style coffee maker, which quickly prepares an individual cup of coffee.

2. Description of the Related Art

Recently, a pour-on-demand (POD) coffee maker, which quickly prepares an individual cup of coffee, has become very popular. In these POD coffee makers, it is common to use a prefilled pouch or “pod” that is insertable into the machine to provide the raw materials from which the beverage is prepared. Such pods typically comprise precompressed, single servings of ground coffee that are enclosed in filter paper.

Accordingly, a POD coffee maker includes a holder, which receives a pouch, that comprises at least one outflow opening and an access opening for placing the pouch in the holder. The POD coffee maker further comprises a cover for closing and releasing the access opening and clamping means for pressing the holder and the cover towards each other when the cover closes off the access opening of the holder.

When, in use, under high pressure, hot water is supplied to the holder for preparing coffee. However, if the seal between the cover and the holder is not sufficient or if there is an improper closure of the cover and the holder, water may leak from the holder. If water leaks out, even if only to a slight extent, the pressure in the holder decreases, which leads to a deterioration of the quality of the coffee extract obtained.

Accordingly, there is a need in the market for a POD coffee maker capable of providing a secure and efficient seal between a holder of a coffee pouch and a cover of the holder, thereby guaranteeing a high quality coffee extract.

### SUMMARY OF THE INVENTION

It is, therefore, an object of the present invention to provide an apparatus for preparing a beverage, such as coffee in which a secure an efficient seal between a holder of a pouch containing a beverage media, such as coffee, and a cover of the holder is established.

It is another object of the present invention to provide an apparatus for preparing coffee including a simplified means for opening and closing an access opening thereof.

According to an aspect of the present invention, the above and other objects of the present invention are provided by an apparatus for preparing coffee. The apparatus includes: a lid portion and a body portion, which are hingedly connected to open and close from and to each other, forming an access opening therebetween; a holder, which is mountable on the body portion in the access opening, for receiving a coffee pouch; a cover, which is fixed to the lid portion in the access opening, for covering and sealing the coffee pouch in the holder; a plurality of engaging members, which are pivotably attached within the lid portion and protrude into the access opening at a perimeter of the cover, each having opposite first and second engaging ends; and a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder.

According to another aspect, the present invention provides an apparatus for preparing coffee, which includes: a lid portion and a body portion, which are hingedly connected to open and close from and to each other, forming an access opening therebetween; a holder, which is mountable on the body portion in the access opening, for receiving a coffee pouch; a cover, which is fixed to the lid portion in the access opening, for covering and sealing the coffee pouch in the holder; a plurality of engaging members, which are pivotably attached within the lid portion and protrude into the access opening at a perimeter of the cover, each having opposite first and second engaging ends; a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder; and an actuator, which is moveably mounted within the lid portion of the apparatus, for applying a downward force on the second engaging ends of the plurality of engaging members, causing the first engaging ends of the plurality of engaging members to separate from the plurality of hook members.

According to yet another aspect, the present invention provides an apparatus for preparing coffee, which includes: a lid portion and a body portion, which are hingedly connected to open and close from and to each other, forming an access opening therebetween; a holder, which is mountable on the body portion in the access opening, for receiving a coffee pouch; a cover, which is fixed to the lid portion in the access opening, for covering and sealing the coffee pouch in the holder; a plurality of engaging members, which are pivotably attached within the lid portion and protrude into the access opening at a perimeter of the cover, each having opposite first and second engaging ends; a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder; and a handle, which is moveably mounted within the lid portion of the apparatus, for opening and closing the lid portion, and for applying a downward force on the second engaging ends of the plurality of engaging members, causing the first engaging ends of the plurality of engaging members to separate from the plurality of hook members. The handle is pivotably mounted at the top side of the lid portion, such that when an upward force is applied to a first end of the handle, a second end of the handle applies a downward force on the second engaging ends of the plurality of engaging members.

### BRIEF DESCRIPTION OF THE DRAWINGS

The above and other objects, features, and advantages of the present invention will become more apparent from the following detailed description when taken in conjunction with the following drawings in which:

FIG. 1 is a perspective view illustrating a POD coffee maker according to a preferred embodiment of the present invention;

FIG. 2 is a perspective view illustrating the POD coffee maker of FIG. 1, in which an access opening is accessible;

FIG. 3 is a side cross-sectional view of the POD coffee of FIG. 1;

FIGS. 4A, 4B, and 4C are side cross-sectional views of the POD coffee of FIG. 1, illustrating a procedure for accessing the access opening according to a preferred embodiment of the present invention;

FIGS. 5A and 5B are front and side views, respectively, illustrating a latching device according to a preferred embodiment of the present invention;

FIGS. 6A and 6B are perspective views illustrating the latching device of FIGS. 5A and 5B, in a latched and unlatched state, respectively; and

FIG. 7 is a cross-sectional view illustrating an alternate embodiment of the latching mechanism of a POD coffee maker according to the present invention.

### DETAILED DESCRIPTION OF THE PREFERRED EMBODIMENT

A preferred embodiment of the present invention will now be described in detail herein below with reference to the annexed drawings. In the following description, the same or similar components in the drawings are designated by the same reference numerals as far as possible although they are shown in different drawings. Additionally, a detailed description of known functions and configurations incorporated herein has been omitted for conciseness.

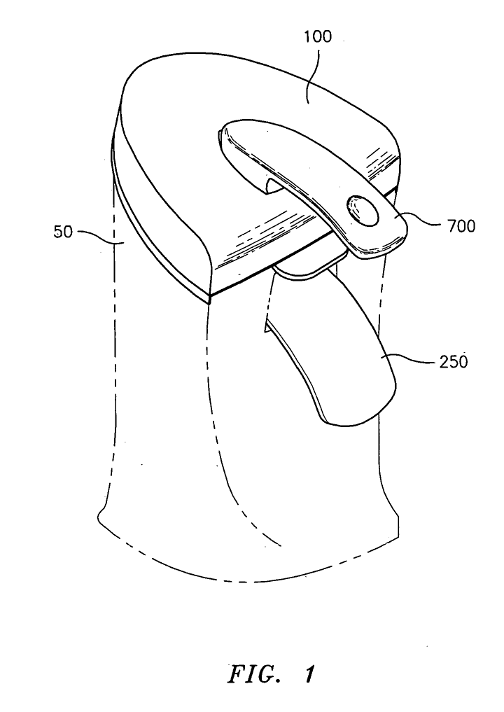

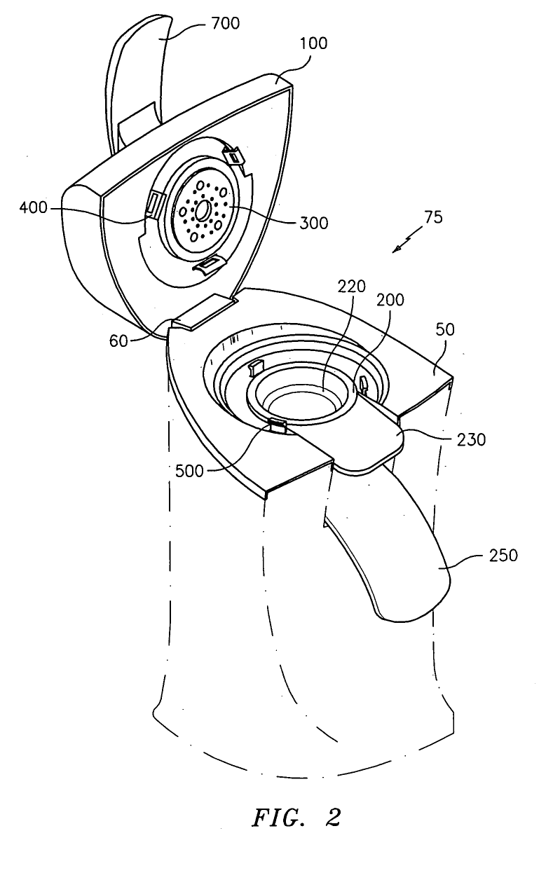

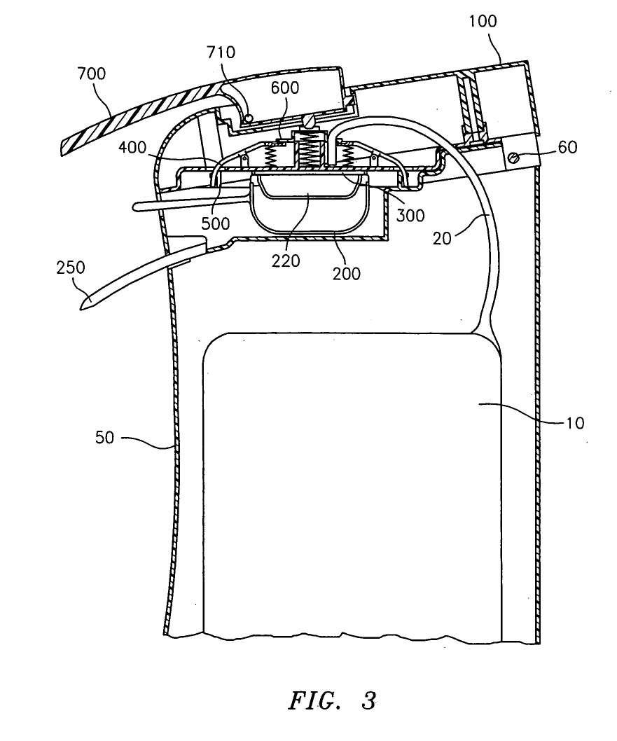

FIGS. 1-3 illustrate a POD coffee maker according to a preferred embodiment of the present invention. More specifically, FIG. 1 is a perspective view illustrating the POD coffee maker according to a preferred embodiment of the present invention, FIG. 2 is a perspective view illustrating the POD coffee of FIG. 1, wherein an access opening is accessible, and FIG. 3 is a side cross-sectional view of the POD coffee of FIG. 1.

As illustrated in FIGS. 1-3, the POD coffee maker according to the present invention includes a body portion 50 and lid portion 100, which are connected by a main hinge 60. The lid portion 100 opens and closes from and to the body portion 50 at the main hinge 60, thereby revealing and closing an access opening 75. Preferably, a handle 700 is provided in the lid portion 100 to facilitate the opening and closing.

More specifically, the body portion 50 includes a holder 200, a pour spout 250, and a plurality of hook members 500. The holder 200 is centrally positioned on a top surface of the body portion 50 for receiving a coffee pod in a recess 220 therein. Preferably, the holder 200 sits within a cavity on the top surface of the body portion 50, and can be removed using a handle 230, such that the holder can be easily cleaned. Further, a bottom surface of the holder includes either at least one hole or a screen that enables water, i.e., the brewed coffee, after being applied to the coffee pod, to drain down through the pour spout 250 into a coffee cup. The plurality of hook members 500, which will be described in more detail herein below, are part of a latch mechanism that is used to close the lid portion 100 on the body portion 50, and seal the coffee pod in the recess 220 of the holder 200. Preferably, the plurality of hook members 500 are fixed or formed equidistantly from each other on the top surface of the body portion 50, outside a perimeter of the holder 200.

The lid portion 100 includes a cover 300, a plurality of engaging members 400, and an actuator 600. The cover 300 is attached to a bottom surface of the lid portion 100 and completely seals the recess 220 of the holder 200, when the lid portion 100 is closed on the body portion 50. Preferably, the cover 300 includes at least one hole or the like for providing heated water to the sealed coffee pod in the recess 200, and a gasket or similar sealing device for providing a more efficient seal at the periphery of the of the cover 300 and the recess 200.

Preferably, the water is heated in a heater assembly (not shown), which can include any known heating assembly such as a boiler tank or immersion heater. The water is held in a reservoir 10 and then passed from the reservoir 10 to the heater and then to the cover 300 via a water hose 20, which can be constructed using plastic tubing, that runs from the heater assembly to the cover 300. The plurality of engaging members 400 correspond to the plurality of hook members 500 on a one to one basis. That is, each of the plurality of engaging members 400 aligns with and engages to a corresponding one of the plurality of hook members 500. The actuator 600, which will be described in more detail herein below, is used to disengage the plurality of engaging members 400 from the plurality of hook members 500, when opening the lid portion 100 from the body portion 50.

As indicated above, an important factor in the operation of a POD coffee maker is the effectiveness of the seal between the holder 200 and the cover 300. Therefore, the plurality of engaging members 400 and the plurality of hook members 500 are designed such that when the lid portion 100 is closed on the body portion 50, the plurality of engaging members 400 and the plurality of hook members 500 are engaged (locked), thereby effectively sealing the cover 300 on the holder 200. The operation of the plurality of engaging members 400 and the plurality of hook members 500 will be described in more detail herein below.

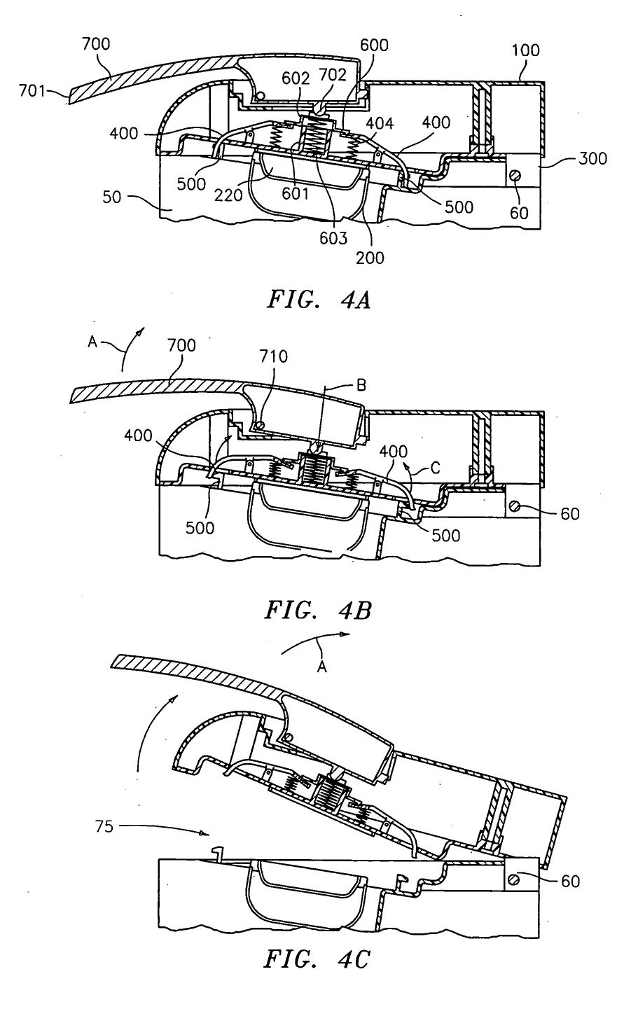

FIGS. 4A, 4B, and 4C are side cross-sectional views of the POD coffee of FIG. 1, illustrating the access opening according to a preferred embodiment of the present invention. More specifically, FIGS. 4A, 4B, and 4C will be described herein below to illustrate operation of the plurality of engaging members 400 and the plurality of hook members 500, with the lid portion 100 and the body portion 50, respectively.

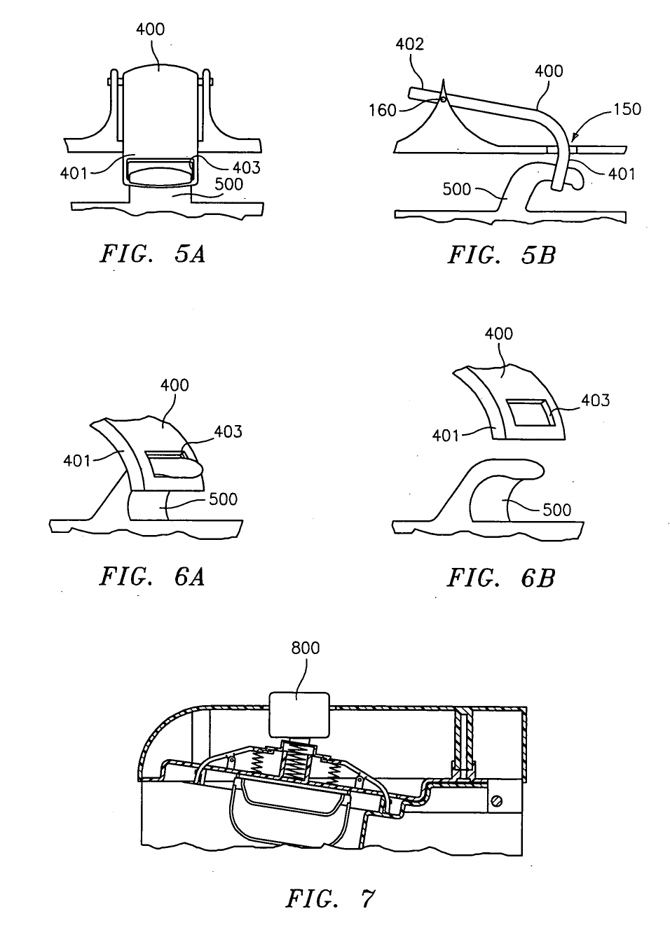

However, before the operation the plurality of engaging members 400 and the plurality of hook members 500 is described, the construction the plurality of engaging members 400 and the plurality of hook members 500 will be described with reference to FIGS. 5A, 5B, 6A, and 6B.

FIGS. 5A and 5B are front and side views, respectively, illustrating the latching device according to a preferred embodiment of the present invention. That is, FIGS. 5A and 5B illustrate one of each of the plurality of engaging members 400 and the plurality of hook members 500 in an engaged (or latched) state. Additionally, FIG. 6A is a perspective view of one of each of the plurality of engaging members 400 and the plurality of hook members 500 in the engaged state.

Referring to FIGS. 5A and 5B, the engaging member 400 includes a first end 401 and a second end 402. The first end, which is includes an engagement opening 403 for receiving the hook member 500, passes through an opening 150 in the bottom surface of the lid portion 100. The second end 402 is opposite the first end 401 of the engaging member 400, and contacts the actuator 600 within the lid portion 100. The engaging member 400 is pivotably attached at the interior of the bottom surface by an engaging hinge 160, such that the first end 401 is moved away, i.e., disengaged, from the hook member 500 when a downward force is applied to the second end 402 of the engaging member 400. FIG. 6B is a perspective view of the engaging member 400 and the hook member 500 in the disengaged state.

Referring to FIG. 4A, the lid portion 100 is closed on the body portion 50. Further, the plurality of engaging members 400 and the plurality of hook members 500 are engaged as illustrated in FIGS. 4A and 6A. Preferably, in the engaged state, a plurality of engaging spring springs 404, which are fixed on the inner surface of the bottom of the lid portion 100, provide an upward force on the second ends 402 of the plurality of engaging members 400, thereby ensuring the engaged state.

Referring to FIG. 4B, preferably, the handle 700 is pivotably attached to the upper surface of the lid portion 100 by a handle hinge 710. More specifically, when an upward force as indicated by arrow A is applied to a first end 701 of the handle 700, the handle pivots on the handle hinge 710, thereby providing a downward force, as indicated by arrow B, upon the actuator 600 at the second end 702 of the handle 700.

Preferably, the actuator is embodied as a resistive piston member. The resistive piston member includes a base cylinder 601, which is fixed within the lid portion 100, a reciprocating cylinder 602 having an upper portion that is in contact with the second ends 402 of the plurality of engaging members 400, which moves up and down within the base cylinder 601, for applying a downward force on the second engaging ends 402 of the plurality of engaging members 402, and a resistive member 603, for example, a coil spring, for providing an upward resistive force on the reciprocating cylinder 602.

Accordingly, when the upward force indicated by arrow A is applied to the first end 701 of the handle 700 and the downward force indicated by arrow B is applied to the actuator 600, the upper portion of the reciprocating cylinder 602 applies a downward force upon the second engaging ends 402 of the plurality of engaging members 400. The downward force applied to the second engaging ends 402 of the plurality of engaging members 400 pivots the plurality of engaging members 400 on their respective engaging hinges 160, thereby moving the first engaging ends 401 of the plurality of engaging members 402 in the directions indicated by arrows C. As a result, the first ends 401 of the plurality of engaging members 400 are moved away, i.e., disengaged, from the plurality of hook members 500 as illustrated in FIG. 6B.

After the plurality of engaging members 400 and the plurality of hook members 500 are disengaged, the lid portion 100 is free to open from the body portion 50. More specifically, once the plurality of hook members 500 are disengaged, the upward force indicated by arrow A lifts the lid portion 100 away from the body portion 50, thereby revealing the access opening 75.

Accordingly, the lid portion 100 can be closed to the body portion 50 using the handle 700. When a downward force is applied to the first end 701 of the handle 700, the handle 700 pivots on the handle hinge 710, thereby removing the force applied to the actuator 600. Because the actuator 600 no longer applies any downward force on the second engaging ends 402 of the plurality of engaging members 400, the plurality of engaging members 402 move back to their original position, from the upward force applied to the second ends 402 of the plurality of engaging members 400, by the engaging springs 404. As a result, when the lid portion 100 is closed to the body portion 50, the plurality of engaging members 400 and the plurality of hook members 500 re-engage, thereby providing an effect seal between the holder 200 and the cover 300, preferably with a gasket.

FIG. 7 is a cross-sectional view illustrating an alternate embodiment of a POD coffee maker according to the present invention. More specifically, in FIG. 7, the handle 700 as described above, is replaced with a push button 800. When the push button 800 is pressed down, it provides a downward force to actuator 600, which in turn disengages the plurality of engaging members 400 and the plurality of hook members 500, similar to the embodiment described above. When the plurality of engaging members 400 and the plurality of hook members 500 are disengaged, the lid portion 100 can be opened from the body portion 50. When the push button 800 is released, the resistive member 603, for example, a coil spring, provides an upward force on the reciprocating cylinder 602, which in turn pushes the push button 800 back to its original position.

Although preferred embodiments have been described above, in which the accuator applies a downward force to the second engaging ends of the engaging members, it should also be appreciated that the present invention can be implemented in embodiments in which the handle or the push button apply the downward force directly to the second engaging ends of the engaging members.

To summarize, the present invention provides an apparatus for preparing a beverage, such as coffee in which a secure an efficient seal between a holder of a pouch containing a beverage media, such as coffee, and a cover of the holder is established. Further, the present invention provides an apparatus for preparing coffee including a simplified means for opening and closing an access opening thereof. That is, according to a preferred embodiment of the present invention a user applies an upward force the handle 700, i.e., lifts the handle 700, the thereby pivoting the handle 700 on the handle hinge 710. The second end 702 of the handle 700 then applies a downward force on the accuator 600, which in turn, applies a downward force on the second ends 402 of the engaging members 400. The engaging members 400 then pivot upon the engaging hinges 160, thereby detaching the first ends 401 of the engaging members 400 from the corresponding hook members 500. When the first ends 401 of the engaging members 400 are detached from the corresponding hook members 500, the cover 300 is free to separate from the recess 220 of the holder 200, and the upward force applied to the handle 700 opens the lid portion 100 from the body portion 50, thereby exposing the recess 220 of the holder 200.

At this point, a coffee pod is placed in the recess 220, and the lid portion 100 is closed back onto the body portion 50, thereby enclosing the coffee pod with the recess 220 of the holder 200. The first ends 401 of the engaging members 400 engage with the corresponding hook members 500, thereby locking the lid portion 100 onto the body portion 50, and the cover 300 onto the recess 220. As indicated above, preferably the cover 300 includes a gasket for effectively sealing the cover 300 onto the recess 220. Thereafter, hot water is passed into the recess 220 to make coffee from the coffee pod. The brewed coffee is then poured down the pour spout 250.

While the present invention has been shown and described with reference to a certain preferred embodiment thereof, it will be understood by those skilled in the art that various changes in form and details, may be made therein without departing from the spirit and scope of the present invention. For example, while the present invention has been described using three hook and engaging members, respectively, it should be appreciated by those skilled in the art that an equivalent device could be designed with a different number of hook and engaging members (e.g., two, four, five, etc.).

What is claimed is:

1. An apparatus for preparing coffee, comprising:
a lid portion and a body portion, which are hingedly connected to open and close from and to each other, forming an access opening therebetween;
a holder, which is mountable on the body portion in the access opening, for receiving a coffee pouch;
a cover, which is fixed to the lid portion in the access opening, for covering and sealing the coffee pouch in the holder;
a plurality of engaging members, which are pivotably attached within the lid portion and protrude into the access opening at a perimeter of the cover, each having opposite first and second engaging ends; and
a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder.

2. The apparatus of claim 1, further comprising:
an actuator, which is moveably mounted within the lid portion of the apparatus, for applying a downward force on the second engaging ends of the plurality of engaging members, causing the first engaging ends of the plurality of engaging members to separate from the plurality of hook members.

3. The apparatus of claim 2, further comprising:
a handle, which is mounted to a top side of the lid portion and extends away from the hinged connection of the lid portion and the body portion, for opening the lid portion away from the body portion.

4. The apparatus of claim 3, wherein the handle is pivotably mounted at the top side of the lid portion, such that when an upward force is applied to a first end of the handle, a second end of the handle applies a downward force on the actuator within the lid portion, thereby providing the downward force on the second engaging ends of the plurality of engaging members.

5. The apparatus of claim 2, further comprising:
a push button, which is moveably mounted at a top side of the lid portion, above the actuator, such that when the push button is pressed, a downward force is applied to the actuator, thereby providing the downward force on the second engaging ends of the plurality of engaging members.

6. The apparatus of claim 2, wherein the actuator comprises a resistive piston member.

7. The apparatus of claim 6, wherein the resistive piston member comprises:
a base cylinder, which is fixed within the lid portion;
a reciprocating cylinder, which moves up and down within the base cylinder, for applying the downward force on the second engaging ends of the plurality of engaging members; and
a spring for providing an upward resistive force on the reciprocating cylinder.

8. The apparatus of claim 1, further comprising:
a plurality of resistive members for applying an upward force to the second engaging ends of the plurality of engaging members, thereby strengthening the interlocking of the first engaging ends with the plurality of engaging members.

9. The apparatus of claim 1, further comprising:
a handle, which is mounted to a top side of the lid portion and extends away from the hinged connection of the lid portion and the body portion, for opening the lid portion away from the body portion.

10. The apparatus of claim 9, wherein the handle is pivotably mounted at the top side of the lid portion, such that when an upward force is applied to a first end of the handle, a second end of the handle applies the downward force on the second engaging ends of the plurality of engaging members.

11. The apparatus of claim 1, further comprising:
a push button, which is moveably mounted at a top side of the lid portion, above the actuator, such that when the push button is pressed, a downward force is applied to the second engaging ends of the plurality of engaging members.

12. An apparatus for preparing coffee, comprising:
a lid portion and a body portion, which are hingedly connected to open and close from and to each other, forming an access opening therebetween;
a holder, which is mountable on the body portion in the access opening, for receiving a coffee pouch;
a cover, which is fixed to the lid portion in the access opening, for covering and sealing the coffee pouch in the holder;
a plurality of engaging members, which are pivotably attached within the lid portion and protrude into the access opening at a perimeter of the cover, each having opposite first and second engaging ends;
a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder; and
an actuator, which is moveably mounted within the lid portion of the apparatus, for applying a downward force on the second engaging ends of the plurality of engaging members, causing the first engaging ends of the plurality of engaging members to separate from the plurality of hook members.

13. The apparatus of claim 12, wherein the handle is pivotably mounted at the top side of the lid portion, such that when an upward force is applied to a first end of the handle, a second end of the handle applies a downward force on the actuator within the lid portion, thereby providing the downward force on the second engaging ends of the plurality of engaging members.

14. The apparatus of claim 12, further comprising:
a push button, which is moveably mounted at a top side of the lid portion, above the actuator, such that when the push button is pressed, a downward force is applied to the actuator, thereby providing the downward force on the second engaging ends of the plurality of engaging members.

15. The apparatus of claim 12, wherein the actuator comprises a resistive piston member.

16. The apparatus of claim 15, wherein the resistive piston member comprises:
a base cylinder, which is fixed within the lid portion;
a reciprocating cylinder, which moves up and down within the base cylinder, for applying the downward force on the second engaging ends of the plurality of engaging members; and
a spring for providing an upward resistive force on the reciprocating cylinder.

17. The apparatus of claim 12, further comprising:
a plurality of resistive members for applying an upward force to the second engaging ends of the plurality of engaging members, thereby strengthening the interlocking of the first engaging ends with the plurality of engaging members.

18. The apparatus of claim 17, wherein the resistive members are springs.

19. An apparatus for preparing coffee, comprising:
a lid portion and a body portion, which are hingedly connected to open and close from and to each other, forming an access opening therebetween;
a holder, which is mountable on the body portion in the access opening, for receiving a coffee pouch;
a cover, which is fixed to the lid portion in the access opening, for covering and sealing the coffee pouch in the holder;
a plurality of engaging members, which are pivotably attached within the lid portion and protrude into the access opening at a perimeter of the cover, each having opposite first and second engaging ends;
a plurality of hook members, which are formed on the body portion in the access opening at a perimeter of a mounting area of the holder, for interlocking with the first engaging ends of the plurality of engaging members on a one to one basis, when the lid portion is closed against the body portion, thereby closing the access opening and sealing the coffee pouch between the cover and the holder; and
a handle, which is moveably mounted within the lid portion of the apparatus, for opening and closing the lid portion, and for applying a downward force on the second engaging ends of the plurality of engaging members, causing the first engaging ends of the plurality of engaging members to separate from the plurality of hook members;
wherein the handle is pivotably mounted at the top side of the lid portion, such that when an upward force is applied to a first end of the handle, a second end of the handle applies a downward force on the second engaging ends of the plurality of engaging members.

20. The apparatus of claim 19, wherein the handle includes a resistive piston member.

21. The apparatus of claim 20, wherein the resistive piston member comprises:
a base cylinder, which is fixed within the lid portion;
a reciprocating cylinder, which moves up and down within the base cylinder, for applying the downward force on the second engaging ends of the plurality of engaging members; and
a spring for providing an upward resistive force on the reciprocating cylinder.

22. The apparatus of claim 19, further comprising:
a plurality of resistive members for applying an upward force the second engaging ends of the plurality of engaging members, thereby strengthening the interlocking of the first engaging ends with the plurality of engaging members.

23. The apparatus of claim 22, wherein the resistive members are springs.
